(19) United States
(12) Patent Application Publication
(10) Pub. No.: US 2013/0062498 A1
(43) Pub. Date: Mar. 14, 2013

(54) POWER TOOL AND SUSPENSION DEVICE FOR THE POWER TOOL

(71) Applicants: Yoshihiro ITO, Anjo-shi (JP); Masamichi MIYAZAWA, Anjo-shi (JP)

(72) Inventors: Yoshihiro ITO, Anjo-shi (JP); Masamichi MIYAZAWA, Anjo-shi (JP)

(73) Assignee: MAKITA CORPORATION, Anjo-shi (JP)

(21) Appl. No.: 13/603,988

(22) Filed: Sep. 5, 2012

(30) Foreign Application Priority Data
Sep. 14, 2011 (JP) 2011-200967

(51) Int. Cl. F16M 13/02

(52) U.S. Cl. 248/672

(57) ABSTRACT

The suspension device includes a ring for hanging the power tool and a ring retaining member provided at an upper part of a housing of the power tool. The housing has a grip at a lower part thereof. The ring retaining member is configured such that the ring is movable between a standing position and a lying position and that the ring is retainable in the standing position.

### BACKGROUND OF INVENTION

This application claims the benefit of Japanese Patent Application Number 2011-200967 filed on Sep. 14, 2011, the entirety of which is incorporated by reference.

### TECHNICAL FIELD

The present invention relates to a power tool such as an electric power tool and an air tool, and a suspension device used for the power tool.

### BACKGROUND ART

A power tool equipped with a suspension device as disclosed in Japanese Patent Application Laid-open No. 01-193183A is known in the art. The suspension device includes a yoke made of rigid metal wire, and a running loop or shackle to be inserted into the yoke. One end of the yoke is formed as a circular loop for surrounding a cylindrical portion of the tool housing, while the other end of the yoke is connected to a bearing at the rear end wall of the tool housing.

However, according to this power tool equipped with the suspension device, since the yoke rotates around the circular loop and the bearing, the yoke is not self-sustainable. Further, since the running loop is merely inserted into the yoke, the running loop is not self-sustainable. Accordingly, when the user engages the yoke or the running loop with a hook provided in a worksite, he has to retain one of the yoke and the running loop in a stand-up position by one hand while holding the hook by the other hand. Therefore, the user has to use both hands when he is hanging the power tool on the hook, which leads to poor usability of the tool.

Further, as the circular loop of the metallic yoke contacts the tool housing, relatively loud noise may be generated, for example, when the yoke rotats. The user may feel uncomfortable abrasive sound during the hanging operation of the power tool. Moreover, such contact noise may also be generated due to contact between the yoke and the running loop.

Further, since the yoke is attached to the tool housing in such a manner that is not self-sustainable, the tool housing is unable to support the force from the yoke. Therefore, the yoke does not protect the tool from impact and the like. The same can be said for the running loop.

In view of the above, it would be desirable to provide a power tool and a suspension device for the power tool, which can be easily operated so that the user can perform by one hand the hanging operation of the power tool at a worksite and the like.

### SUMMARY OF THE INVENTION

In accordance with a first aspect of the present invention, as embodied and described herein, there is provided a power tool equipped with a suspension device, the suspension device comprising a ring for hanging the power tool, a ring retaining member provided at an upper part of a housing of the power tool, the housing having a grip at a lower part thereof, wherein the ring retaining member is configured such that the ring is movable between a standing position and a lying position and that the ring is retainable in the standing position.

In a second aspect of the present invention, the power tool according to the first aspect may be configured such that an elastic member is provided on the ring retaining member in a position contacting the ring.

In a third aspect of the present invention, the power tool according to the first aspect may be configured such that the ring retaining member is provided on the housing in such a manner as to extend outward from the housing.

In a fourth aspect of the present invention, the power tool according to the first aspect may be configured such that the ring retaining member is separated from the housing and that the ring retaining member is attached to the housing by a fixing member used for the housing.

In a fifth aspect of the present invention, the power tool according to the first aspect may be configured such that the ring retaining member is arranged at an intersecting portion between an upward extension of the grip and the upper part of the housing.

In a sixth aspect of the present invention, the power tool according to the first aspect may further comprise a leaf spring configured to retain the ring in the standing position.

In accordance with a seventh aspect of the present invention, as embodied and described herein, there is provided a suspension device for a power tool comprising: a ring for hanging the power tool and a ring retaining member configured such that the ring is movable between a standing position and lying position and that the ring is retainable in the standing position.

In an eighth aspect of the present invention, the suspension device according to the seventh aspect may be configured such that an elastic member is provided on the ring retaining member in a position contacting the ring thereof.

With the configurations of the power tools according to the first, fifth and sixth aspects of the present invention, since the ring is movable between the standing position and the lying position and retainable in the standing position, a power tool can be easily operated by the user with one hand in the hanging operation of the power tool at a worksite and the like.

Further, with the configuration of the power tool according to the second aspect of the present invention, in addition to the above advantageous, a power tool can be manufactured by a relatively low cost and suppress the contact noise.

Further, with the configuration of the power tool according to the third aspect of the present invention, in addition to the above advantageous, it is possible to provide a power tool which is protected from impact and the like.

Further, with the configuration of the power tool according to the fourth aspect of the present invention, in addition to the above advantageous effects, a power tool can be manufactured by a relatively low cost because of its simple structuire.

With the configurations of the suspension devices according to the seventh and eighth aspects of the present invention, since the suspension device includes the ring and the ring retaining member, the ring is detachably mounted to the power tool in such a manner as to be movable between the standing position and the lying position and retainable in the standing position. Therefore, the user can readily select whether or not the ring is used with the power tool, so that the suspension device is readily applicable in accordance with various use conditions.

### BRIEF DESCRIPTION OF THE DRAWINGS

To better understand the claimed invention, and to show how the same may be carried into effect, reference will now be made, by way of example only, to the accompanying drawings, in which:

FIG. 1 is a perspective view of an impact wrench according to the present invention;

FIG. 2 is a partly exploded enlarged perspective view showing an upper front side of the impact wrench of FIG. 1; and

FIG. 3 is a side view of a suspension device shown in FIG. 2.

### DETAILED DESCRIPTION OF THE EXEMPLARY EMBODIMENT

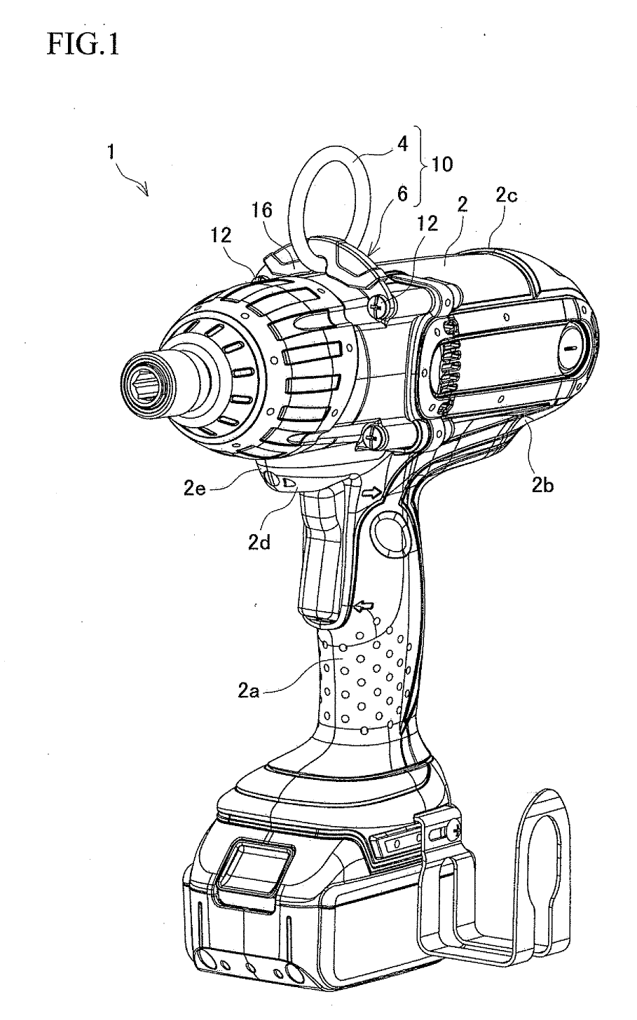

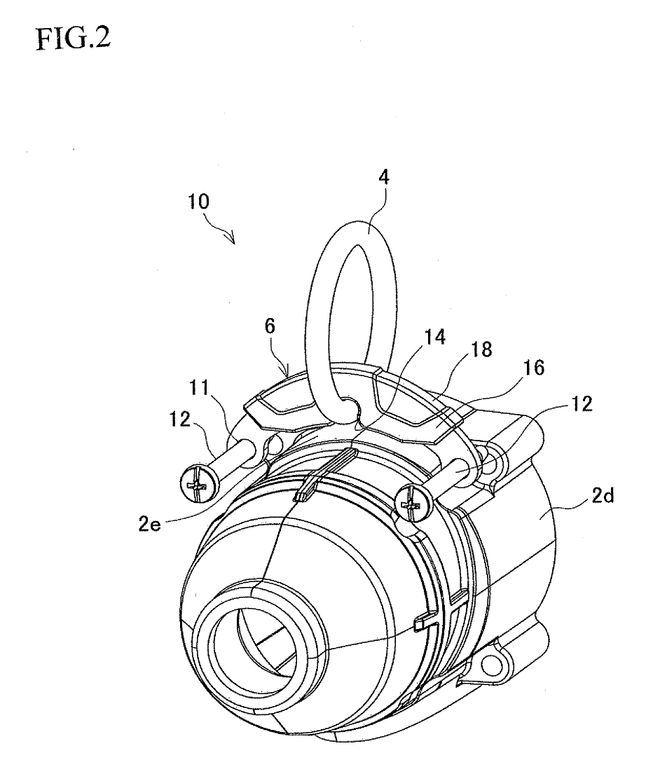

With reference to the accompanying drawings, one exemplary embodiment of the present invention will be described below. FIG. 1 is a perspective view of a rechargeable impact wrench as an example of a power tool. FIG. 2 is a partly exploded enlarged perspective view showing an upper front side of the rechargeable impact wrench.

As shown in FIG. 1, an impact wrench 1 includes a housing 2 having a grip 2a at a lower part of the housing 2. A suspension device 10 including a ring 4 and a bracket 6 is arranged at an upper center portion of the housing 2.

The suspension device 10 is arranged at the upper center portion of the housing 2 where an upward extension of the grip 2a and the upper part of the housing 2 intersect. In this exemplary embodiment, the ring 4 and the bracket 6 are arranged partially in a region of the intersecting portion. However, the ring 4 and the bracket 6 may partially cover the entire region of the intersecting portion. As an alternative, the whole part of the ring 4 or the bracket 6 may be arranged in the region of the intersecting portion.

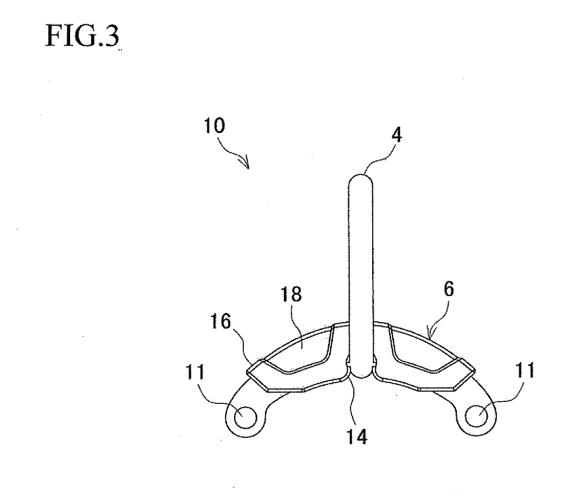

FIG. 3 is a side view of a suspension device 10. The ring 4 is sized to be engageable with a hook, for example, provided in a high-place worksite. The ring 4 is made of metal.

The bracket 6 as an example of a ring retaining member is a plate-like member. The bracket 6 is attached to the housing 2 in a standing posture (i.e., in such a manner as to extend outward from the housing 2) by screws 12 inserted into the housing 2 through screw holes 11 formed at both ends of the bracket 6. The bracket 6 is separated from the housing 2.

The screws 12 are also used to attach front-side portions 2d, 2e to proximal portions 2b, 2c of the housing 2. In other words, the screws 12 for connecting the bracket 6 to the housing 2 are also used as a fixing member for the housing 2. The bracket 6 is arranged orthogonal to an axis of the output shaft of the impact wrench 1.

A lower side (and an upper side) of the bracket 6 is generally contoured to have a profile corresponding to an outer shape of the housing 2 in an area where the bracket 6 is attached to the housing 2. A recess 14 is formed in a center portion of the lower side of the bracket 6 to receive the ring 4.

The recess 14 is in shape corresponding to a part of the cross-section of the ring 4 and the part of the ring 4 is received in the recess 14 so that the ring 4 is rotatably supported by the outer surface of the housing 2 and the recess 14. The ring 4 is parallel to the output shaft (i.e., the center axis of the ring 4 is orthogonal to the axis of the output shaft) when the ring 4 is received in the recess 14 in the upright standing position.

A planar elastic member 16 made of a material (e.g. rubber) having higher friction coefficient with respect to the ring 4 is arranged at the outer surface of the recess 14. As the elastic member 16 contacts the ring 4, the bracket 6 has a contacting portion for contacting the ring 4 through the elastic member 16. The elastic member 16 wraps around the upper side (outer surface) of the bracket 6, and is configured to receive therein a plate-like base 18, which is made of metal having rigidity higher than that of the elastic member 16.

Since the ring 4 is received in the recess 14 and rotatably supported by the housing 2, the ring 4 is movable between a standing position and a lying position by a manual operation of the user. The movable range of the ring 4 is defined from one lying position in which the ring 4 is in contact with one end of the bracket 6 (or a portion of the housing 2 adjacent to the one end) to the other lying position in which the ring 4 is brought into contact with the other end of the bracket 6 (or a portion of the housing 2 adjacent to the other end) via the standing position in which the ring 4 protrudes outward from the housing 2.

Further, since the ring 4 contacts the elastic member 16 contoured to have a profile corresponding to a part of the cross-section of the ring 4 within the recess 14, the ring 4 can be stationarily held in the standing position because of the elasticity (static friction) of the elastic member 16. In other words, the bracket 6 can retain the ring 4 in the standing position by the recess 14 and the elastic member 16 while allowing the movement of the ring 4 between the standing position and the lying position.

When the ring 4 is in the lying position, the ring 4 is positioned along the housing 2 or the bracket 6 to prevent the ring 4 from being an obstacle. On the contrary, when the ring 4 is kept in the standing position, the user can hang the ring 4 arranged at the upper part of the housing 2 (at an intersecting portion with the upward extension of the grip 2a) on a hook, such as a hoist, provided in a worksite, while holding the grip 2a of the impact wrench 1 by one hand. Accordingly, the user can easily perform the hanging operation (hooking operation) of the impact wrench 1.

Further, since the bracket 6 is formed by providing the elastic member 16 onto the base 18, the bracket 6 can retain the ring 4 in a desired position with adequate strength. Further, since the elastic member 16 contacts the ring 4, the ring 4 and the bracket 6 are protected and an occurrence of the contact noise can be prevented.

Further, since the bracket 6 with high rigidity protrudes from the housing 2, the impact wrench 1 can be protected from impact and the like exerted from the bracket 6 side. Accordingly, the bracket 6 for supporting the ring 4 works as a protector. Because of the configuration in which the elastic member 16 is arranged outside the bracket 6, it is possible to reduce impact so that the bracket 6 and an object hitting/being hit the bracket 6 can be more reliably protected.

In addition to the above advantageous effects, since the bracket 6 is attached to the housing 2 using the screws 12 for connecting the front-side portions 2d, 2e to the proximal portions 2b, 2c of the housing 2, it is not necessary to provide dedicated screws, which leads to an efficient structure.

Further, since the bracket 6 protrudes outward from the housing 2, the bracket 6 for supporting the ring 4 can work as a protector. Because of the configuration in which the elastic member 16 is arranged outside the bracket 6, the bracket 6 can receive an object hitting the bracket 6 softly by the elastic member 16. As a result, sufficient protection can be achieved.

Furthermore, since the bracket 6 is attached to the housing 2 by the screws for connecting the front-side portions 2d, 2e to the proximal portions 2b, 2c of the housing 2, the bracket 6 can be installed without increasing the number of constituent parts.

In addition to the above advantageous effects, since the bracket 6 is separated from the housing 2 and configured to be detachably mounted to the housing 2, the bracket 6 can be removed from the housing 2 when it is not in use. When in use or upon manufacture of the suspension device 10, the bracket 6 can be easily attached to the housing 2.

Although the present invention has been described with reference to the above exemplary embodiment, the present invention is not limited to the above specific embodiment and various changes and modifications may be made without departing from the scope of the appended claims. For example, the entire shape or the sectional shape of the ring is not limited to the one described in the above embodiment; the ring may have a shape other than a circular ring or the ring may have one or more slits. The ring may be directed along a direction orthogonal to the output shaft when the ring is in the standing position. Further, the ring and/or the bracket may be made of materials different from those described in the above embodiment. The elastic member may be modified so as not to wrap around the outer surface of the bracket. The fixing member may be pins, rivets or combination thereof, in place of the screws or with the screws. The bracket as an example of the ring retaining member may be formed integrally with the housing, which means that the ring retaining member may be integral with the housing. The ring and the bracket may be arranged at the upper part of the housing at a position other than the intersecting portion with the upward extension of the grip. The present invention is not limited to the impact wrench and may be applicable to other power tools. Further, the present invention is not limited to a power tool driven by electricity and may be applicable to other power tools, for example, driven by air and engine.

The bracket may include a leaf spring so that the ring is retained in the standing position by the leaf spring. To be more specific, the leaf spring is arranged such that when the ring is about to move from the standing position toward the lying position, the elastic force of the leaf spring acts on the ring to prevent the ring from falling over until a predetermined force is applied to the ring, but allows the ring to move into the lying position if the force greater than the predetermined force is applied. The leaf spring may be replaced with or used in combination with other elastic members to retain the ring in the standing position. It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims, It is explicitly stated that all value ranges or indications of groups of entities disclose every possible intermediate value or intermediate entity for the purpose of original disclosure as well as for the purpose of restricting the claimed invention, in particular as limits of value ranges.

What is claimed is:

1. A power tool equipped with a suspension device, the suspension device comprising:
a ring for hanging the power tool; and
a ring retaining member provided at an upper part of a housing of the power tool, the housing having a grip at a lower part thereof,
wherein the ring retaining member is configured such that the ring is movable between a standing position and a lying position and that the ring is retainable in the standing position.

2. The power tool according to claim 1, wherein an elastic member is provided on the ring retaining member in a position contacting the ring.

3. The power tool according to claim 1, wherein the ring retaining member is provided on the housing in such a manner as to extend outward from the housing.

4. The power tool according to claim 1, wherein the ring retaining member is separated from the housing, and wherein the ring retaining member is attached to the housing by a fixing member used for the housing.

5. The power tool according to claim 1, wherein the ring retaining member is arranged at an intersecting portion between an upward extension of the grip and the upper part of the housing.

6. The power tool according to claim 1, further comprising a leaf spring configured to retain the ring in the standing position.

7. A suspension device for a power tool comprising:
a ring for hanging the power tool; and
a ring retaining member configured such that the ring is movable between a standing position and lying position and that the ring is retainable in the standing position.

8. The suspension device according to claim 7, wherein an elastic member is provided on the ring retaining member in a position contacting the ring.
